(19) United States
(12) Patent Application Publication
(10) Pub. No.: US 2004/0219433 A1
(43) Pub. Date: Nov. 4, 2004

(54) Current collector coating and method for applying same

(76) Inventors: Simon Besner, Coteau du Lac (CA); Richard Laliberte, Ste-Julie (CA); Alain Vallee, Varennes (CA)

Correspondence Address: SMART & BIGGAR, 1000 de la Gauchetiere Street West, Suite 3400, Montreal, QC, H3B4W5, CA

(21) Appl. No.: 10/428,089

(22) Filed: May 2, 2003

(51) Int. Cl. H01M 4/64; B05D 5/12; H01M 4/66; B05C 1/04

(52) U.S. Cl. 429/233; 29/2; 427/58; 429/245; 118/256

(57) ABSTRACT

The present invention provides a method for applying an electrically conductive coating on at least a portion of a sheet-like component of an electrochemical (EC) cell. The method comprises providing an electrically conductive material having a flowable consistency and applying it on the sheet-like component while creating a shearing stress in the electrically conductive material to form the coating. The invention also concerns an apparatus capable of implementing the method.

### FIELD OF THE INVENTION

The present invention relates to electrochemical equipment and, more specifically, to an electrically conductive coating for the current collecting element of an electrochemical cell. This invention also concerns a method for applying the electrically conductive coating as well as an apparatus for implementing the method.

### BACKGROUND OF THE INVENTION

In recent years, the field of electrochemical equipment and, more specifically, that of energy storage devices (i.e., batteries) has generally been characterized by a certain effervescence. In fact, ever increasing and evolving demand, research and development, and greater competition in the market place are all factors that are contributing to numerous innovations in this field. Moreover, manufacturers and users of devices are also envisioning alternate and diversified applications for these products.

One innovation that has particularly marked the field of electrochemical equipment was the advent of solid lithium metal polymer electrolyte batteries (LMPB). Such batteries display numerous advantages over more conventional aqueous-electrolyte batteries, namely: lower overall battery weight; higher power density; higher specific energy; and longer service life. In addition, they are also more environmentally friendly.

Individual electrochemical cells for solid LMPB technology generally include the following components: positive electrodes (i.e., cathodes); negative electrodes (i.e., anodes); and a separator material capable of permitting ionic conductivity, such as a solid polymer electrolyte, sandwiched between the electrodes. In addition, current collecting elements can also be positioned adjacent to each electrode. In particular, a current collecting element is preferably positioned adjacent to the cathode. Current collecting elements are typically constructed of aluminum, nickel, steel, copper, and the like, and act to conduct the flow of electrons between the electrodes which they are positioned adjacent to, and the terminals of the battery. In certain cases, the current collecting element can also provide support for the cathode material since the latter can have a paste-like structure.

However, a problem typically encountered when dealing with LMPB technology is the fact that the current collecting elements have a tendency to react when in direct contact with their associated electrodes resulting in the formation of passivation films or in the degradation (corrosion) of the surface of the collectors. The formation of passivation films on the surface of the collectors greatly alters the quality of the electronic exchanges between the collectors and the electrode active materials. Such is the case, notably, for the current collecting element associated with the cathode. This leads to an inadequate or interrupted interfacial contact between the current collecting components and the active material of their associated electrodes, thereby increasing the internal resistance of the electrochemical cell and reducing power output, columbic efficiency, and cycle life of the cell.

The attack of the collectors or the formation of passivation films at their surfaces is caused by oxidation-dissolution of the metallic collector resulting from radicals, acid-base reactions or oxidation-reduction chemical reactions more or less catalyzed by the materials present.

In dry polymer cells, the reaction observed on the aluminum current collector of a vanadium oxide-based cathode is the formation of a oxygen-based film of aluminum that reaches thickness' higher than that of the alumina films initially present at the surface of the aluminum. Such a film impairs the passage of electrons between the collector and the active material of the electrode.

In order to overcome the above deficiency, a protective coating layer or primer layer can be positioned between the current collecting elements and their associated electrodes. The ideal coating layer must be chemically compatible with the active materials of the electrodes to prevent chemical reactions leading to a progressive deterioration of the electronic exchange between the current collectors and the active materials of the electrodes and therefore decline of the performance of the generator during cycling. The coating layer must also enhance adhesion between the current collecting element and its associated electrode, be electrically conductive and still be as thin as possible to minimize its size and weight since it does not contribute to the electrochemical reaction generating power.

Current collector coatings are generally well known in the art. For example, U.S. Pat. No. 5,262,254 discloses the use of a carbon based primer consisting of a redox active conductive polymer such as polypyrrole, polythiophene, polyphenylene and polyaniline layered on the cathodic current collecting element to prevent the corrosion of the latter. U.S. Pat. No. 5,478,676 discloses a primer which is operatively placed on the surface of the current collecting element, thereby not only improving adhesion between the current collecting element and its associated electrode but also making the current collecting element more resistant to organic solvents. The primer comprises a polymeric material having pendant carboxylic acid groups crosslinked and a conductive filler. Furthermore, U.S. Pat. No. 5,580,686 teaches a primer layer, which consists of an inorganic binder such as lithium polysilicate and a carbon conductive filler, that is disposed between the current collecting elements and their associated electrodes. The lithium polysilicates comprise several limitations because of their strong basicity. For example, they are reactive towards acidic electrode active materials such as vanadium oxide. Furthermore, they are chemically reactive with iron phosphate-type materials. Their basic character also renders them incompatible with conduction additives made of conjugated polymers of the polyaniline type, doped polypyrole type etc. For example, when a carbon based lithium polysilicate solution is contacted with a typically orange coloured vanadium oxide powder, the solution turns to a green colour resulting from the chemical reaction between the lithium polysilicate binder of the solution and the solid oxide. This chemical reaction is undesirable since it leads to a progressive deterioration of the electronic exchange between the current collector and a vanadium oxide based electrode.

Moreover, although the use of current collector coatings is fairly widespread and well known, the prior art is fairly silent with respect to methods for applying the coating in an effective and feasible manner.

One method for applying such a coating is disclosed in U.S. Pat. No. 6,306,215, wherein a composition of an adhesive polymer and conductive filler is mixed with a solvent and placed in a reservoir. A first roller is partially submerged in the reservoir and effects the transfer of the coating material therefrom to the current collecting element; the latter traversing a nip formed by the first roller and a second roller placed in adjacency with the first roller. The solvent is thereafter evaporated to leave a dry protective coating. Although the method disclosed is effective, excessive amounts of coating material must be used to properly coat the current collecting element due to the type of coating action employed. More specifically, the coating is effected through the action of the first roller which rotates in a direction that coincides with the direction of travel of the current collecting element, as the latter comes into contact with the first roller.

Another coating method is taught in U.S. Pat. No. 6,007,588 in which an adhesive promoter layer is coated onto a current collector by plasma polymerization in a reaction chamber. This method is obviously expensive and inadequate for large scale production.

Considering this background, it clearly appears that there is a need in the industry for an electrically conductive protective coating for current collectors that alleviates the short comings of prior art coatings and for a simple and cost-efficient method and apparatus for applying an electrically conductive protective coating onto a current collecting element.

### SUMMARY OF THE INVENTION

Under a first broad aspect, the invention seeks to provide a method for applying an electrically conductive coating on at least a portion of a sheet-like component of an electrochemical cell. The method comprises: providing electrically conductive material having a flowable consistency; applying the electrically conductive material on the sheet-like component; and creating a shearing stress in the electrically conductive material to form the coating.

In a specific and non-limiting example of implementation, the method further comprises: depositing the electrically conductive material on an applicator; and creating a relative movement between the applicator and the sheet-like component to transfer the electrically conductive coating material on the sheet-like component while creating the sheer-stress in the electrically conductive material.

Continuing with the above example of implementation, the applicator comprises a pair of adjacent rotatable rollers which rotate in the same direction and which define a nip through which the sheet-like component traverses. Preferably, the sheet-like component is in the form of a continuous web and is suitable for use as a current collecting element for an electrochemical cell. Moreover, the electrically conductive material comprises soluble compounds selected from the group consisting of potassium polyphosphates, potassium polyborates, potassium mixed silicate, potassium mixed polyphosphates-silicates, potassium mixed polyborates-silicates and potassium mixed polyphosphate/borate-silicates, to which is combined conductive additives such as carbon or graphite.

Under a second broad aspect, the invention seeks to provide an apparatus for applying an electrically conductive coating on at least a portion of a sheet-like component of an electrochemical cell. The apparatus comprises a source of electrically conductive material and an applicator upon which the electrically conductive coating material can be deposited. The applicator is capable of relative motion with the sheet-like component to transfer the electrically conductive material onto the sheet-like component while creating a shearing stress in the electrically conductive material to form the coating.

In a specific and non-limiting example of implementation, the applicator comprises a pair of adjacent rotatable rollers which rotate in the same direction and which define a nip through which the sheet-like component traverses. Preferably, the sheet-like component is in the form of a continuous web and is suitable for use as a current collecting element for an electrochemical cell. Moreover, the electrically conductive material comprises an alkali metal silicate, preferably potassium silicate, and carbon.

Continuing with this example of implementation, the source of electrically conductive coating material is a in the form of reservoir which is in fluid communication with one of the pair of rollers.

Under a third broad aspect, the invention seeks to provide an apparatus for applying an electrically conductive coating on at least a portion of a sheet-like component of an electrochemical cell. The apparatus comprises: a reservoir containing electrically conductive coating material; a pair of rotatable rollers including first and second rotatable rollers which define a nip through which the sheet-like component traverses; and a third rotatable roller partially submerged within the reservoir and in fluid communication with one of the first and second rotatable rollers. When the first and second rotatable rollers are operative, they are capable of relative motion with the sheet-like component to transfer the electrically conductive material thereon while creating a shearing stress in the electrically conductive material to form the coating.

Under a fourth broad aspect, the invention seeks to provide a lithium electrochemical cell comprising: at least one anode; at least one cathode; an electrolyte separator located between the at least one anode and the at least one cathode; a current collecting element associated with the at least one cathode; and a protective coating located between the at least one cathode and the current collecting element. The protective coating, which acts to prevent deterioration of the electronic exchange between the current collecting element and the at least one cathode, comprises a potassium-based soluble compound and a conductive additive.

Preferably, the potassium-based soluble compound is selected from the group consisting of potassium polyphosphates, potassium polyborates, potassium silicate, potassium mixed polyphosphates-silicates, potassium mixed polyborates-silicates and potassium mixed polyphosphate/borate-silicates. Also the conductive additive is preferably selected from the group consisting of carbon and graphite.

### BRIEF DESCRIPTION OF THE DRAWINGS

A detailed description of preferred embodiments of the present invention is provided herein below with reference to the following drawings, in which:

FIG. 1a is a perspective view of an electrochemical cell according to a non-limiting example of implementation of the invention;

FIG. 1b is an enlarged fragmentary view of the coated current collecting element shown in FIG. 1a;

FIG. 2a is a schematic side view of an apparatus for producing the coated current collecting element of FIGS. 1a and 1b; and

FIG. 2b is an enlarged view of the coating mechanism depicted in FIG. 2a.

In the drawings, preferred embodiments of the invention are illustrated by way of examples. It is to be expressly understood that the description and the drawings are only for the purpose of illustration and as an aid to understanding. They are not intended to be a definition of the limits of the invention.

### DETAILED DESCRIPTION OF THE DRAWINGS

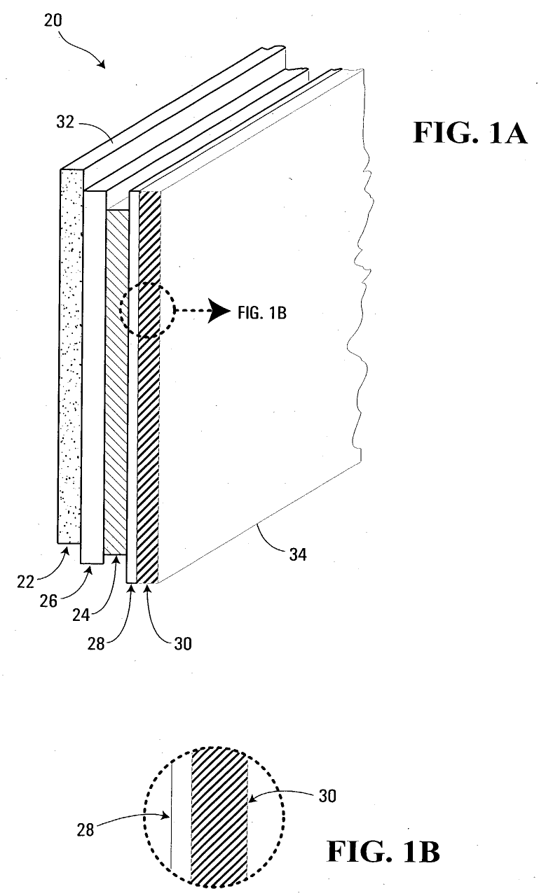

With reference to FIG. 1a, there is shown an electrochemical cell 20. Electrochemical cell 20, more specifically, comprises a negative sheet-like electrode 22 (generally referred to as an anode), a positive sheet-like electrode 24 (generally referred to as a cathode), and an electrolyte separator 26 interposed between the former and the latter. In addition, a sheet-like cathode current collecting element 30, which features an electronically conductive coating 28, is positioned near the cathode 24.

FIG. 1a further shows that anode 22 is slightly offset with respect to the current collecting element 30 such as to respectively expose the anode 22 and the current collecting element 30 along first and second ends 32, 34 of the electrochemical cell. Each of the above components will now be described in greater detail.

In a preferred embodiment, anode 22 is a lithium or lithium alloy metallic sheet or foil, which acts both as a cation source and as a current collector. Anode 22 may also comprise an anode current collecting element distinct from the active anode material. For instance, anode 22 may be a composite comprising an anode current collecting element preferably made of a thin sheet of copper, a polymer, an electronic conductive filler, and an intercalation material. Examples of the electronic conductive filler include but are not limited to: conductive carbon, carbon black, graphite, graphite fiber, and graphite paper. Any intercalation material known to those skilled in the art may be used and, in particular, may be selected from the group consisting of: carbon, activated carbon, graphite, petroleum coke, a lithium alloy, nickel powder, and lithium intercalation compound. The anode may further comprise a lithium salt. Other materials can, however, also be used to form anode 22. As mentioned, although FIG. 1 does not depict anode 22 as including a structurally distinct current collecting element, it should be expressly understood that an anode having such a feature remains within the scope of the present invention. A distinct current collector for the anode is typically made of copper.

With respect to cathode 24, the latter typically comprises a polymer binder, a lithium salt, and electrochemically active material. Examples of suitable electrochemically active materials include: LiₓV_{y}O_{z}; LiCₒO_{z}; LiₓMn_{y}O_{z}; LiNiO₂; LiFePO₄; VₓO_{y}; Mn_{y}O_{z}; Fe(PO₄)₃; or LiₓTi_{y}O_{z}. In a preferred embodiment, cathode 24 preferably comprises lithiated vanadium oxide (LiₓV_{y}O_{z}). Any other suitable active material can, however, be used to form the cathode 24.

Electrolyte separator 26, which is preferably but not necessarily made of polymer mixed with a lithium salt, physically separates the anode 22 and the cathode 24 and also acts as an ion transporting membrane.

Current collecting element 30, which serves the primary function of conducting the flow of electrons between the active material of cathode 24 and the terminals of a battery (not shown), is typically constructed of material such as copper, nickel, aluminum, and the like.

Although FIGS. 1a and 1b depict an electrochemical cell in a mono-face configuration (i.e., wherein a current collecting element is associated with each anode/electrolyte/cathode element combination), it should be specifically understood that the present invention contemplates other electrochemical cell configurations as well. For example, a bi-face electrochemical cell configuration (i.e., wherein a common current collecting element is associated with a pair of anode/electrolyte/cathode element combinations) can also be used without departing from the spirit of the invention.

FIG. 1b shows current collecting element 30 and its protective electrically conductive coating 28 in greater detail. As stated previously, protective conductive coating 28 acts, among others, to prevent chemical reactions leading to the formation of passivation films on the surface of the current collecting element 30 or to the degradation of the current collecting element 30 itself through corrosion. Although not shown to scale, FIG. 1b shows that coating 28 is fairly thin when compared with current collecting element 30. In reality, the thickness of coating 28 generally varies between 1 and 5 μm while that of current collecting element 30 generally varies between 10 and 20 μm. Coating 28, in theory, must be as thin as possible (since it does not contribute to the electrochemical reaction that is responsible for power-generation), yet must still be able to protect current collecting element 30 adequately. Coating 28 should preferably be of constant or homogeneous thickness and cover the entire surface areas of the current collecting element in contact with its associated electrode for optimal interfacial contact between current collecting element 30 and cathode 24. However, in dry polymer medium, wherein complete dissolution of the current collecting element 30 is not observed, it is not necessary to cover the entire surface of the current collecting metal, as long as only the non-coated surface will eventually passivate without hindering the electronic exchanges at the protected surface areas.

Preferred embodiments of the protective conductive coating according to the invention include vitreous and vitreous/mineral binders obtained from water soluble precursors and neutralized at a pH comprised between 4 and 9, and preferably about 7, in which is dispersed an electronic conductive additive, such as carbon black and/or graphite particles, in sufficient quantity to induce electronic conductivity to the coating essential for the maintenance of electron exchanges between the metallic substrate and the cathode active materials. The electronic conductive additive may be dispersed in the solution in an amount varying from 5% to 25%. A controlled pH thus prevents acid-base reactions between the vitreous binder or vitreous/mineral binder and the cathode active materials during cycling of the electrochemical generator. It should be noted that although the electronic conductive additive preferably comprises carbon black and/or graphite particles, other electronic conductive additives may be used such as, for example, metallic particles.

Preferred vitreous and vitreous/mineral binders include aqueous solutions of potassium oxide (K₂O) or preferably potassium hydroxide (KOH) mixed with amorphous silica (O₂Si) to form soluble compounds of potassium mixed silicate; aqueous solutions of boron oxide (B₂O₃, B(OH)₃) or boronic hydroxide (H₃BO₂) and/or phosphorous oxide (P₂O₅) or phosphoric acid (HPO₃) mixed and neutralized at a pH comprised between 4 and 9 with potassium oxide (K₂O) and/or potassium hydroxide (KOH) to form soluble compounds of potassium polyphosphates, including linear or cyclic metaphosphates and ultraphosphates or potassium polyborates or mixtures thereof such as potassium polyphosphate/borates. Amorphous silica (O₂Si) may be added to the aqueous solution to increase the capacity of the resulting compound to form vitreous or semi-vitreous links thereby forming compounds of potassium polyphosphates-silicates or potassium polyborates-silicates as well as potassium polyphosphate/borate-silicates. The precursors and the resulting compounds must be soluble in water and be predominantly vitreous or vitreous/mineral once dried. The aqueous forms of the compounds and their vitreous derivatives (once dried) may comprises a mixture of monomer, polymer and cyclic species.

These compounds represent preferred embodiments to wet and thus protect all or part of the surface of the metallic current collectors 30. Further, the preparation of these compounds in solution in water allows control of their pH values thus preventing acid-base reactions between the binder and the electronic conduction additive or the electrode active materials during cycling.

Potassium based compounds such as potassium silicates are available on the market and are favourable to rapid drying because they are less hygroscopic than other metal silicates. Potassium is also known to be a superior electrical and ionic insulator thereby providing relatively good corrosion resistance when applied onto an aluminium current collector. The presence of potassium in the polymer binder does not harm the performance of the electrochemical generator as other metal silicates do. Furthermore, potassium is thermodynamically stable in the presence of metallic lithium.

Glass-forming additives such as hydrolysed silica, siloxanes, aluminates, organometallic titanates partly or completely hydrolysed may be included in the vitreous and vitreous/mineral binders as long as they remain chemically compatible with the conduction additive and the electrode active materials i.e. as long as their acid-base properties can be controlled to prevent chemical reactions impairing the operation of the generator.

The aqueous protective conductive solution is then coated onto the metallic current collector as will be explained below in an example. For the composite cathode to adequately adhere to the protective conductive coating as well as to reduce any the potential of undesired chemical reactions with the lithium anode, the water content of the vitreous or vitreous/mineral binder should be reduced to a minimum. To do so, the coated current collector 30 may be dried by any suitable medium either immediately after the aqueous protective conductive solution is coated onto current collector 30 or immediately prior to the step of applying the composite cathode layer 24 in order to eliminate traces of water that might affect the generator performance. One preferred method of drying the protective conductive coating is by circulating the coated current collector under an infra-red lamp which rapidly evaporates the water particles remaining in the coating. Any other method which effectively dries the protective conductive coating is well within the scope of the present invention.

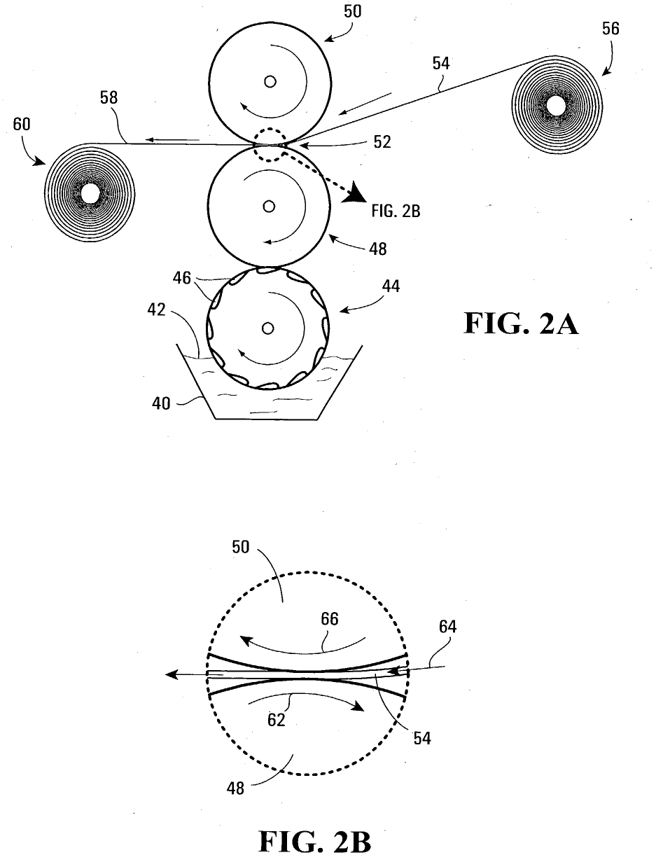

FIG. 2a schematically illustrates a method for applying coating 28 onto current collecting element 30 according to a non-limiting example of implementation of the invention. As shown, a reservoir 40 initially contains a quantity of a solution of conductive coating material 42 in liquid form. Partially submerged within the liquid coating material 42 is a rotatable roller 44 which includes a plurality of small pockets 46 along its outer periphery. As rotatable roller 44 rotates within reservoir 40, liquid coating material 42 fills pockets 56 and adheres thereto. Thus, liquid coating material 42 is transported by rotatable roller 44 until it is transferred onto another rotatable roller 48; the latter being in fluid communication with the former. Rotatable roller 48 preferably comprises an outer surface layer made of an absorptive material such as an elastomer layer to enhance its ability to hold liquid coating material and to spread the liquid coating material. Disposed adjacent to rotatable roller 48 is an additional rotatable roller 50 which rotates in the same direction as rotatable roller 48. Rotatable rollers 48 and 50 together define a nip 52 which a continuous web 54 of current collecting material traverses as it is progressively unwound from a roll 56. Liquid coating material 42 is coated onto continuous web 54 when the latter traverses the nip. Specifically, the liquid coating material 42 is transferred from rotatable roller 48 onto one side of continuous web 54. Upon exiting the nip 52, the coated continuous web 58 can subsequently be wound onto a roll 60 (as shown), or it can alternatively be brought to a further processing station such as a drying station to evaporate excess water from the applied solution of conductive coating material 42 (not shown).

FIG. 2b is an enlarged view depicting the coating mechanism of FIG. 2a. As shown, roller 50 rotates in a direction designated by arrow 66 while continuous web 54 travels in a direction designated by arrow 64. Since roller 50 and continuous web 54 are travelling in essentially the same direction as continuous web 54 enters nip 52, roller 50 acts as a driver to help continuous web 54 traverse nip 52. As depicted by arrow 62, roller 48 rotates in a clockwise direction that is essentially the same as that of roller 50. In contrast to roller 50, however, roller 48 rotates in a direction which is opposite to that of continuous web 54 as the latter enters nip 52. A shearing stress is thereby created between the surface of roller 48 and the traveling continuous web which transfers the liquid coating material 42 onto continuous web 54. This shearing action ensures that the resulting coating on continuous web 54 is as thin and as even (i.e., homogeneous) as possible, given its ultimate use. In addition, liquid coating material 42 is used more optimally since wastage is reduced.

The expression “shearing stress”, as used herein, refers to the action resulting from the friction forces between roller 48 and continuous wed 54 sliding in substantially opposite directions relative to each other at at least one point, that causes the transfer of liquid coating material from roller 48 to continuous wed 54.

Although the coating applicator depicted in the drawings is in the form of a pair of rollers defining a nip, it should be expressly understood that alternative types of coating applicators which are also capable of creating a shear stress in the coating material remain within the scope of the present invention. For example, a linear applicator which travels in a direction opposite to that of the substrate to be coated could also be used. In addition, a method in which the rotatable roller which applies the coating is also the one which is submerged in the liquid coating material also remains within the scope of the present invention.

FIGS. 2 and 2a further show that only one side of continuous web 54 is coated with liquid coating material 42. It should be expressly understood, however, that a continuous web 54 having both sides coated remains within the spirit of the present invention. This would be the case, notably, when coated continuous web 58 is to be used for making the current collecting elements of a bi-face electrochemical cell.

Although the above figures specifically describe a method for applying an electrically conductive coating on the current collecting element of an electrochemical cell, it should be understood that such a method could be used for coating additional components of an electrochemical cell.

Although various embodiments have been illustrated, this was for the purpose of describing, but not limiting, the invention. Various modifications will become apparent to those skilled in the art and are within the scope of this invention, which is defined more particularly by the attached claims.

1. A method for applying an electrically conductive coating on at least a portion of a sheet-like component of an electrochemical cell, said method comprising:
providing electrically conductive material having a flowable consistency;
applying the electrically conductive material on the sheet-like component; and
creating a shearing stress in the electrically conductive material to form the coating.

2. A method as defined in claim 1, further comprising:
depositing the electrically conductive material on an applicator;
creating a relative movement between said applicator and the sheet-like component to transfer the electrically conductive material on the sheet-like component while creating the shearing stress in the electrically conductive material.

3. A method as defined in claim 2, wherein said applicator comprises at least one rotatable roller upon which the electrically conductive material is deposited.

4. A method as defined in claim 3, wherein said applicator includes a pair of adjacent rotatable rollers defining a nip through which the sheet-like component traverses.

5. A method as defined in claim 4, wherein said pair of adjacent rotatable rollers rotate in substantially the same direction to effect the transfer of the electrically conductive material onto the sheet-like component.

6. A method as defined in claim 5, wherein said sheet-like component is in the form of a continuous web.

7. A method as defined in claim 1, wherein said sheet-like component is suitable for use as a current collector for an electrochemical cell.

8. A method as defined in claim 7, wherein said coating comprises a potassium-based soluble compound.

9. A method as defined in claim 8, wherein said coating further comprises a conductive additive selected from the set consisting of carbon, graphite, and metallic particles.

10. A coated current collector obtained by the method of claim 1.

11. An apparatus for applying an electrically conductive coating on at least a portion of a sheet-like component of an electrochemical cell, said apparatus comprising:
a source of electrically conductive material;
an applicator upon which the electrically conductive material can be deposited;
said applicator being capable of relative motion with the sheet-like component to transfer the electrically conductive material onto the sheet-like component while creating a shearing stress in the electrically conductive material to form the coating.

12. An apparatus as defined in claim 11, wherein said applicator comprises at least one rotatable roller upon which the electrically conductive material is deposited.

13. An apparatus as defined in claim 12, wherein said rotatable roller is a first rotatable roller, said applicator including a second rotatable roller adjacent said first rotatable roller and defining a nip therewith through which the sheet-like component traverses.

14. An apparatus as defined in claim 13, wherein said first and second rotatable rollers rotate in substantially the same direction.

15. An apparatus as defined in claim 14, comprising a third rotatable roller, said third rotatable roller being in fluid communication with said source of electrically conductive material such as to transfer electrically conductive material from said source to said first rotatable roller.

16. An apparatus as defined in claim 15, wherein said source of electrically conductive material is in the form of a reservoir in which said third rotatable roller is at least partially submerged.

17. An apparatus as defined in claim 16, wherein the sheet-like component is in the form of a continuous web.

18. An apparatus as defined in claim 17, wherein said source of electrically conductive material comprises an alkali metal silicate and carbon.

19. An apparatus as defined in claim 18, wherein said alkali metal silicate is a potassium silicate.

20. An apparatus for applying an electrically conductive coating on at least a portion of a sheet-like component of an electrochemical (EC) cell, said apparatus comprising:
a reservoir containing electrically conductive material;
a pair of rotatable rollers including a first rotatable roller and a second rotatable roller, said first and second rotatable rollers together defining a nip through which the sheet-like component traverses;
a third rotatable roller partially submerged within said reservoir and being capable of rotating therein, said third rotatable reservoir being in fluid communication with either one of said first and second rotatable rollers;
said first and second rotatable rollers when operative being capable of relative motion with the sheet-like component to transfer the electrically conductive material thereon while creating a shearing stress in the electrically conductive material to form the coating.

21. A lithium electrochemical cell, comprising:
at least one anode;
at least one cathode;
an electrolyte separator positioned between said at least one anode and said at least one cathode;
a current collecting element associated with said at least one cathode;
a protective coating located between said current collecting element and said at least one cathode to prevent deterioration of the electronic exchange therebetween, said protective coating comprising a potassium-based soluble compound and a conductive additive.

22. A lithium electrochemical cell as defined in claim 21, wherein said potassium-based soluble compound is selected from the group consisting of potassium polyphosphates, potassium polyborates, potassium silicates, potassium mixed polyphosphates-silicates, potassium mixed polyborates-silicates and potassium mixed polyphosphate/borate-silicates.

23. A lithium electrochemical cell as defined in claim 21, wherein said conductive additive is selected from the group consisting of carbon and graphite.
